(19) United States
(12) Patent Application Publication
(10) Pub. No.: US 2024/0040274 A1
(43) Pub. Date: Feb. 1, 2024

(54) FOLDED SINGLE SENSOR 3-D CAPTURE SYSTEM

(71) Applicant: Summer Robotics, Inc., Campbell, CA (US)

(72) Inventors: Gerard Dirk Smits, Los Gatos, CA (US); Steven Dean Gottke, Concord, CA (US)

(21) Appl. No.: 18/225,833

(22) Filed: Jul. 25, 2023

Related U.S. Application Data
(60) Provisional application No. 63/474,186, filed on Jul. 28, 2022.

(51) Int. Cl. H04N 25/47; H04N 23/95; H04N 23/55; H04N 13/25

(52) U.S. Cl. CPC H04N 25/47; H04N 23/95; H04N 23/55; H04N 13/25; H04N 23/555

(57) ABSTRACT

Embodiments are directed to folded single sensor 3-D capture systems. An enclosure that includes an event camera, one or more beam generators, or an optical focusing system may be provided such that the beam generators may scan a scene. Paths may be scanned across objects in the scene with the beams. Events may be determined based on detection, by the event camera, of beam reflections that correspond to objects in the scene such that each beam reflection may be directed to a separate location on a sensor for the event camera by the optical focusing system. Trajectories may be determined based on the paths and the events such that each trajectory may be a parametric representation of a one-dimensional curve segment in a three-dimensional space. Three-dimensional information that corresponds to the objects may be generated based on the plurality of trajectories.

### CROSS-REFERENCE TO RELATED APPLICATION

This application is a Utility Patent application based on previously filed U.S. Provisional Patent Application U.S. Ser. No. 63/474,186 filed on Jul. 28, 2022, the benefit of the filing date of which is hereby claimed under 35 U.S.C. § 119(e), and the contents of which is further incorporated in entirety by reference.

### TECHNICAL FIELD

The present innovations relate generally to machine sensing or machine vision systems, and more particularly, but not exclusively, to folded single sensor 3-D capture systems.

### BACKGROUND

The state of the art in robotic vision is largely based on cameras where the input to the sensing system is two-dimensional (2D) arrays of pixels that encode the amount of light that each pixel received over an exposure period, or on depth capture technologies (e.g., Time-of-Flight (ToF) cameras, structured light cameras, LIDAR, RADAR, or stereo cameras, to name a few) which provide three-dimensional (3D) point clouds, where each point in the point cloud may store its position in space with respect to the vision system, and may store any of a number of other data associated with the patch of reflecting material that the point was generated from (e.g., brightness, color, relative radial velocity, spectral composition, to name a few). Note that 3D point clouds may be represented in “frames”, similar in spirit to the frames of images from cameras, meaning that they don't have a fundamental representation of continuously evolving time. To provide useful perception output that may be used by machine vision applications, such as, robotic planning and control systems, these 2D or 3D data often need to be processed by machine vision algorithms implemented in software or hardware. In some cases, some machine vision systems may employ machine learning to determine properties or features of the world that may be salient to particular robotic tasks, such as, the location, shape orientation, material properties, object classification, object motion, relative motion of the robotic system, or the like. In many cases, neither the 2D nor 3D representations employed by conventional machine vision systems provide inherent/native support for continuous surface representation of objects in the environment. In some cases, scanning systems may employ multiple scanning sensors (e.g., image cameras, event cameras, or the like) to concurrently scan the same scenes or objects. These approaches may often require two or more event cameras, which can be challenging in applications where small size is important, as well as necessitating complex synchronization protocols. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates an example of a robot 100 with multiple eyes for 3-D perception of a scene in accordance with one or more of the various embodiments;

FIG. 2A illustrates a logical schematic of a virtual layout of a single sensor 3-D measurement system in accordance with one or more of the various embodiments;

FIG. 2B shows more details of possible layouts of an eye system in accordance with one or more of the various embodiments;

FIG. 3 illustrates an endoscope in accordance with one or more of the various embodiments;

FIG. 4 illustrates an overview flowchart of a process for folded single sensor 3-D capture systems in accordance with one or more of the various embodiments;

FIG. 5 illustrates a flowchart of a process for folded single sensor 3-D capture systems in accordance with one or more of the various embodiments;

FIG. 6 illustrates a system environment in which various embodiments may be implemented;

FIG. 7 illustrates a schematic embodiment of a client computer;

FIG. 8 illustrates a schematic embodiment of a network computer;

FIG. 9 illustrates a logical representation of sensors and sensor output information for folded single sensor 3-D capture systems in accordance with one or more of the various embodiments; and

FIG. 10 illustrates a logical schematic of a system for folded single sensor 3-D capture system in accordance with one or more of the various embodiments;

FIG. 11 illustrates how paths associated with scanned beams may traverse over or across a scene in accordance with one or more of the various embodiments; and

FIG. 12 illustrates a representation of how the shape or position of trajectories may correspond to the shapes or positions of subjects that may be scanned in scenes in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the present innovations.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PUP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein the terms “scanning signal generator,” “signal generator,” or “beam scanner” refer to a system or a device that may produce a beam that may be scanned/directed to project into an environment. For example, scanning signal generators may be fast laser-based scanning devices based on dual axis microelectromechanical systems (MEMS) that are arranged to scan a laser in a defined area of interest. The characteristics of scanning signal generator may vary depending on the application or service environment. Scanning signal generators are not strictly limited to lasers or laser MEMS, other types of beam signal generators may be employed depending on the circumstances. Critical selection criteria for scanning signal generator characteristics may include beam width, beam dispersion, beam energy, wavelength(s), phase, or the like. Scanning signal generator may be selected such that they enable sufficiently precise energy reflections from scanned surfaces or scanned objects in the scanning environment of interest. The scanning signal generators may be designed to scan various frequencies, including up to 10s of kHz. The scanning signal generators may be controlled in a closed loop fashion with one or more processors that may provide feedback about objects in the environment and instructs the scanning signal generator to modify its amplitudes, frequencies, phase, or the like.

As used herein, the terms “event sensor,” “event camera sensor,” or” “event camera” refer to a device or system that detects reflected energy from scanning signal generators. Event sensors may be considered to comprise an array of detector cells that are responsive to energy reflected from scanning signal generators. Event sensors may provide outputs that indicate which detector cells are triggered and the time they are triggered. Event sensors may be considered to generate sensor outputs (events) that report the triggered cell location and time of detection for individual cells rather than being limited to reporting the state or status of every cell. For example, event sensors may include event sensor cameras, SPAD arrays, SiPM arrays, or the like.

As used herein the terms “image sensor,” or “frame camera” refer to a device or system that can provide electronic scene information (electronic imaging) based on light or other energy collected at surface the image sensor. Conventionally, image sensors may be comprised of charge-coupled devices (CCDs) or complementary metal oxide semi-conductors (CMOS) devices. In some cases, image sensors may be referred to as frame capture cameras. Also, in some cases, image sensors may be deployed or otherwise used to collect event information.

As used herein the terms “trajectory,” “parametric trajectory,” “surface trajectory” refers to one or more data structures that store or represent parametric representations of curve segments that may correspond to surfaces sensed by one or more sensors. Trajectories may include one or more attributes/elements that correspond to constants or coefficients of segments of one-dimensional analytical curves in three-dimensional space. Trajectories for a surface may be determined based on fitting or associating one or more sensor events to known analytical curves. Sensor events that are inconsistent with the analytical curves may be considered noise or otherwise excluded from trajectories.

As used herein the term “configuration information” refers to information that may include rule-based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the innovations in order to provide a basic understanding of some aspects of the innovations. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to folded single sensor 3-D capture systems. In one or more of the various embodiments, an enclosure that includes an event camera, one or more beam generators, or an optical focusing system may be provided such that the one or more beam generators may scan a scene with one or more beams.

In one or more of the various embodiments, a plurality of paths may be scanned across one or more objects in the scene with the one or more beams.

In one or more of the various embodiments, a plurality of events may be determined based on detection, by the event camera, of two or more beam reflections that may correspond to one or more objects in the scene such that each beam reflection may be directed to a separate location on a sensor for the event camera by the optical focusing system.

In one or more of the various embodiments, a plurality of trajectories may be determined based on the plurality of paths and the plurality of events such that each trajectory may be a parametric representation of a one-dimensional curve segment in a three-dimensional space.

In one or more of the various embodiments, three-dimensional information that corresponds to the one or more objects may be generated based on the plurality of trajectories.

In one or more of the various embodiments, determining the plurality of events may include: determining a position of each beam reflection on the sensor for the event camera based on the detection by the event camera; determining two or more virtual event cameras based on one or more characteristics of the optical focusing system such that each virtual event camera includes a virtual sensor; determining a virtual position of each event on each virtual sensor for each event camera based on the one or more characteristics of the optical focusing system; generating triangulation information associated with the scanned scene based on the determined virtual position of each event; or the like.

In one or more of the various embodiments, providing the optical focusing system may include: providing two or more mirrors that direct the two or more beam reflections to the event camera such that each mirror may be positioned to direct each beam reflection from a different aperture to a separate location on the sensor for the event camera and such that each mirror may be one or more of a flat mirror, a spheric curved mirror, an aspheric curved mirror, or the like.

In one or more of the various embodiments, providing the optical focusing system may include, providing one or more filters that may reduce the ambient light energy or reduce light energy from light wavelengths that are outside of a range of the one or more beams such that the one or more filters reduce the detection of spurious beam reflections at the sensor for the event camera.

In one or more of the various embodiments, providing the optical focusing system may include, providing one or more wedged lenses that may direct the one or more beam reflections to one or more positions on the sensor for the event camera.

In one or more of the various embodiments, providing the optical focusing system may include, providing one or more diffractive optical elements that may direct the one or more beam reflections to the sensor for the event camera.

In one or more of the various embodiments, providing the optical focusing system may include, providing a pinhole camera to direct the one or more beam reflections to the sensor for the event camera.

In one or more of the various embodiments, providing the enclosure may include, including the event camera, the one or more beam generators, or the optical focusing system, in an endoscope.

In one or more of the various embodiments, providing the enclosure may include, including the event camera, the one or more beam generators, or the optical focusing system, on a robot finger.

In one or more of the various embodiments, the enclosure may include one or more frame cameras.

### DETAILED DESCRIPTION

3-D measurement of objects using scanning beams can be accomplished using event cameras. This has been described elsewhere, but briefly involves scanning beam trajectories quickly over the surfaces of objects in the scene. In some embodiments, beam reflections may be observed by a plurality of event cameras that report the location and timestamp of events, which may be generally triggered if the intensity of a spot at a given time is high enough to trigger the threshold of event camera pixels. Event cameras can be implemented in a variety of ways including CMOS sensors, avalanche photodiodes, photo-multiplier arrays, and other methods, but generally timestamps of events at individual pixels may be independent of one another. If a stream of events that may be proximate to each other in time and space may be detected on a camera, they can be connected to form a beam trajectory on that camera. If similar trajectories may be observed on a plurality of cameras that may be well-calibrated with respect to each other, the 3-D positions of the object surfaces can be ascertained using triangulation and tracked over time.

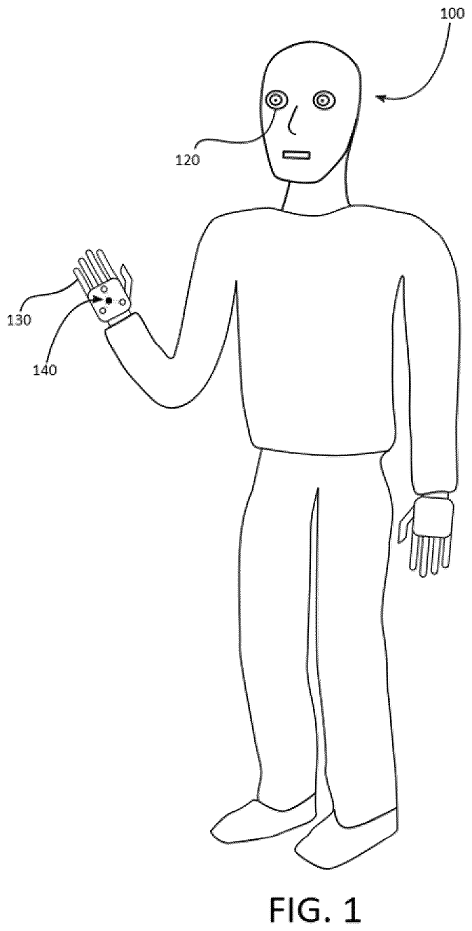

FIG. 1 illustrates an example of a robot 100 with multiple eyes for 3-D perception of a scene in accordance with one or more of the various embodiments. Each eye 120 may include a scanning laser or other beam generator as well as one or more cameras, including frame cameras or event cameras. In some embodiments, robots may include one or more eyes in different parts of its body. In one embodiment, hand 130 of robot 100 may include an eye system, such as eye system 140 that may be used in concert with other eyes in the system for 3-D measurement. In one embodiment, eye system 140 may include a single event camera sensor but have multiple input apertures. In some cases, eye systems may be used for 3-D measurement without the presence of other eyes, such as, eyes 120 in the system.

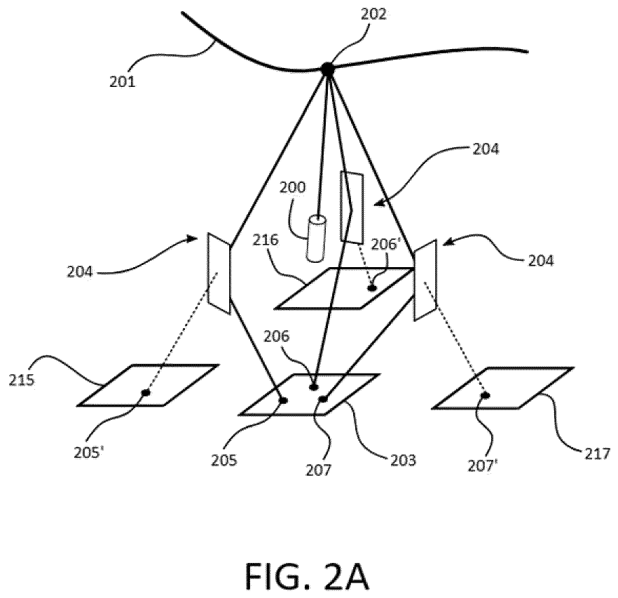

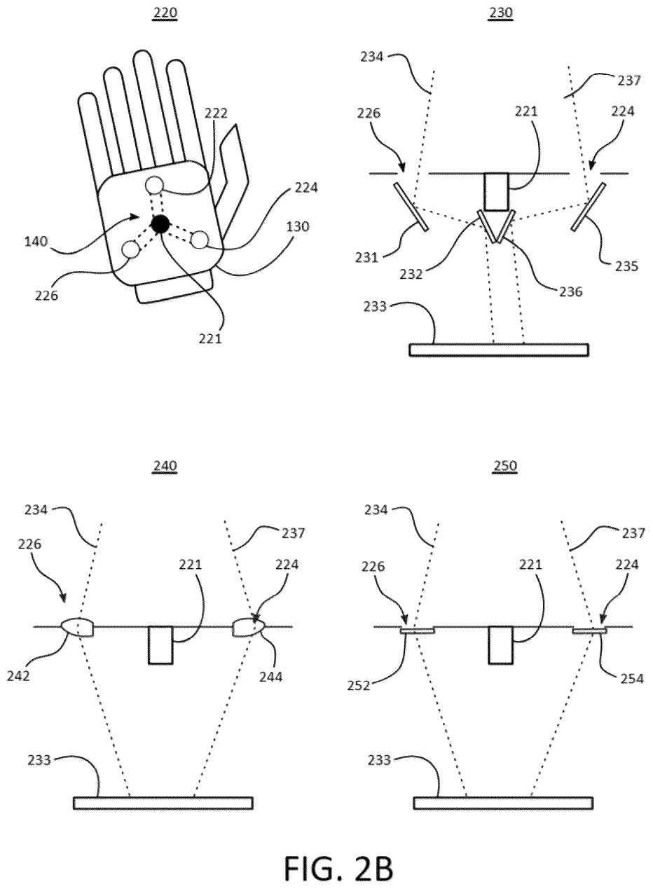

FIG. 2A illustrates a logical schematic of a virtual layout of a single sensor 3-D measurement system in accordance with one or more of the various embodiments. Here laser scanner 200 may be considered to represent a snapshot in time hitting object 201 at point 202. In this example, the light scattering or reflected (e.g., beam reflections) from point 202 may be captured by two or more apertures and folded in toward event camera sensor 203. Without showing specific optical layouts, which would include focusing and other optical elements such as folding mirrors 204, light from the beams may be captured on event camera sensor 203 at two or more different spots, here shown as three spots, including spot 205, spot 206, and spot 207. Though the points may be detected on the same camera sensor (event camera sensor 203), they may be captured from different vantage points. Accordingly, in some embodiments, each point on the event camera sensor may be treated as being detected or captured by separate virtual event cameras, represented here as virtual event camera 215, virtual event camera 216, and virtual event camera 217. Geometrically, the three spots appear to be seen with apparent disparity because of the separation introduced by the optical focusing system, and may be calculated based on the measured positions of their respective virtual event cameras.

FIG. 2B shows more details of possible layouts of an eye system in accordance with one or more of the various embodiments. View 220 shows a close-up of the robot's hand 130, including eye system 140. Centrally positioned (in this example) is beam scanner 221 surrounded by three apertures, aperture 222, aperture 224, and aperture 226 each with light channels that may bring light to a central event camera sensor. In some embodiments, eye system 140 may be at least two apertures but may be able to measure additional details with three or more apertures. In some embodiments, view 230 shows a cross-sectional view of two of the apertures as well as the interior of an eye system, such as eye system 140. In some embodiments, aperture 224 allows light (including energy from beams from a beam scanner or beam generator) to reach mirror 235, which reflects light to central mirror 236 and thence to event camera sensor 233. In some embodiments, light beam 237 may correspond to the reflection of a single point on an object at a given time (e.g., beam reflections). Also, in some embodiments, aperture 226 may allow light onto mirror 231, which may reflect light to a central mirror, such as central mirror 232 and also to the same event camera sensor (event camera sensor 233). In some embodiments, light beam 234 may correspond to the reflection off of a single point that created beam 237. While aperture 222 is not shown in this view, light may be captured through aperture 222 as well. Note, that this example is not drawn to scale, and many configurations of mirrors and or lenses (e.g., optical focusing systems) are possible to achieve the desired internal dimensions.

In some embodiments, optical focusing system may include various components depending on the type focusing system or its performance requirements. Accordingly, in some embodiments, additional optical components may be included before or between the mirrors to focus or otherwise gather light coming into the sensor array. For instance, one or more lenses may be placed at or near aperture 226, between mirror 231 and mirror 232, or over sensor array 233. In some variants, no lenses may be used, but instead one or more of the mirror elements may be spheric curved mirrors or aspheric curved mirrors.

In some embodiments, rather than using optical components, optical focusing system may include a small aperture may be placed in the system as a pinhole camera. Also, in some embodiments, hybrid systems may be possible such that there may be fewer optical components used along with a small aperture. In some embodiments, additional filters may be added to the light input chain to limit or reduce ambient light or energy from wavelengths that may be outside of a range of the light beams to reduce noisy events at the sensors. Also, in some cases, rather than using mirrors, the inside of eye systems may be filled with various materials such as glass or plastic, and air gaps at flat surfaces could reflect incoming beams using total internal reflection.

View 240 shows for some embodiments another embodiment of how a folded optics eye system may be provided. Accordingly, in some embodiments, rather than folding mirrors, optical focusing system may include wedged optics to direct light from points on scanned object surfaces to multiple spots on event camera sensor 233. In some embodiments, this may be implemented using wedged lenses, such as wedged lens 242, wedged lens 244, or the like, where a wedge may be used along with focusing or other lensing functions, but in some cases these components may be physically separated; in this case, element 242 and element 244 may direct (e.g., steer) the light toward the central axis while other focusing components could be added to the optical path. View 250 shows another embodiment where instead diffractive optical elements (DOEs), such DOE 252 and DOE 254 could be used to direct the beam toward the event camera sensor. In some embodiments, focusing or other optical components may be added in the optical path similar to other embodiments. In some cases, systems that include wedges or DOEs may provide improved location precision and improved spot-size if the wavelength of the reflected beams coming into the system may be relatively narrow; greater optical dispersion of the beams leads to a larger spot size on the sensor.

Regardless of the method of light directing within an eye system, each aperture combined with the single event sensor may be treated as a separate event camera for triangulation of the position of beams scanned over surfaces. In some embodiments, the depth range of the camera may be somewhat limited compared to systems with multiple event cameras where the event cameras may be placed at greater distances from one another. In addition, in some embodiments, analysis of the data may be complicated by having multiple events triggered at different points on the event camera sensor for each beam reflection; a trajectory traced on an object surface may leave three different trajectory traces on the eye system sensor. Accordingly, further processing may be performed to disambiguate which trajectory comes from which aperture; the shape of the three trajectories may be correlated somewhat, but the positions and projections may be distorted. Each aperture acts as a port to its own virtual camera, so the virtual camera positions may be precisely calibrated with respect to each other, and certain relationships such as epipolar alignment and other markers may be used to identify the beams in some embodiments. In addition, because each beam may be hitting event camera sensor 233 at different slanted angles, the projection of the image sensor grid may be different for each incoming beam; the pixels around the optical axis of each virtual camera may have an anisotropic shape that may be skewed in a different direction for a given virtual camera. Accordingly, in some embodiments, the distinct skew direction may be another method for disambiguating the beams.

As the trajectories cross over themselves at later times, the virtual crossing points may be measured both at the (X, Y) position on the event camera sensor, but also with two timestamps (t1, t2), which may be the times the beam crossed over the virtual crossing point. Accordingly, a graph built up from continued virtual crossing points may provide another method for disambiguating beams. In an additional embodiment, an eye system may have more than one beam scanners operating simultaneously; these beams may also be identified on the sensor using similar techniques as already described, where several or all of the above techniques could be employed.

In some embodiments, the single sensor eye camera system may have other benefits compared to a multi-camera 3-D measurement system. Normally with two or more cameras, the time bases of each camera must be synchronized with each other down to the time resolution of the cameras, which may be 1 microsecond or faster. This enables the measurement system to determine which points in a trajectory on one camera match up with similar points on one or more other cameras. However, in a single sensor system, this synchronization may be unnecessary. Also, in some embodiments, the overall size of the eye system may be compact because less space may be required for a single camera as compared to multi-camera system.

Also, in some embodiments, another difference between the single sensor systems or multi-sensor systems may be differences in beam focus. In a multi-camera system that may be used to measure objects tens of meters away, focus of captured beams may still be done but is less sensitive since focus is more often set to capture a wide range of depths. In a single sensor system, the depth range may be relatively short, and measurement within its range requires fine-tuned focusing to obtain the desired level of detail. In some embodiments, lenses in the eye system may be configured to provide a best beam focus on the event camera sensor, but in other embodiments, the Z-position of the event camera sensor may be adjusted as well using solenoids or other types of actuators.

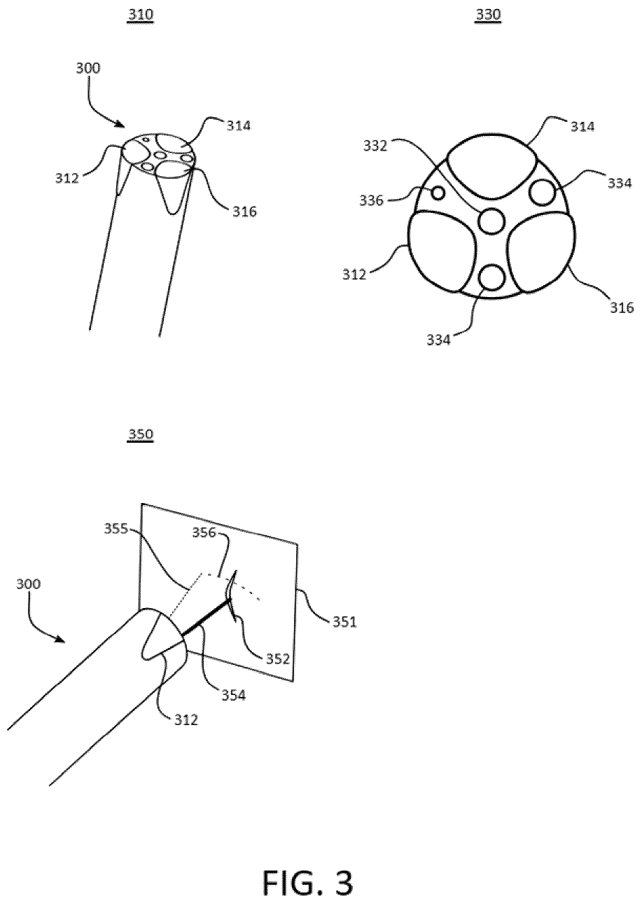

Configurations like those implemented for eye system 140 may also be done at a smaller scale. FIG. 3 illustrates endoscope 300 in accordance with one or more of the various embodiments.

View 310 may be considered a perspective view of one end of endoscope 300. In this example, the tip of endoscope 300 may have three windows such as window 312, window 314, and window 316 that may correspond to apertures, such as aperture 222, aperture 224, and aperture 226 of eye system 140. In some embodiments, the features of endoscope 300 may be more rounded than depicted; the sides may protrude away from the central axis of the endoscope as pictured or may be set flush against it. In some embodiments, the sides of the windows may be opaque or may also allow light to pass in.

View 330 may be considered a top view of the endoscope. Located near the central axis of the tip is a beam scanner 332, which may be directed in a variety of ways; for example one of ordinary skill in the art will be familiar with compact beam scanning systems may employ MEMS or some other methods.

In some embodiments, additional elements may be present. In some embodiments, one or two frame capture cameras, such as, frame camera 334 may be included in the system to capture full-color video frames to supplement 3-D surface data measured by the event camera sensor. Also, in some embodiments, an optical fiber, such as optical fiber 336 may also have one end exposed at the tip of the endoscope. Internally, in some embodiments, the 3-D capture portion may be provided using a variety of different configurations, including those as described for view 230, view 240, view 250, or the like. In some configurations, the inside portion of the outer cylinder near the tip of the endoscope may also be reflective and reflect beams onto other optical elements or directly onto event camera sensor 233. Also, in some embodiments, a frame capture camera, if present, may be able to detect the scanned beams; along with full-color images of the scene they may be viewing, by also capturing scanned trajectories absent fine time resolution that may be provided by event cameras, they may still be able to collect 3-D data as well as localize themselves with respect to the other virtual cameras in the system. Also, in some embodiments, the laser scanner (e.g., beam generator) may be configured operate intermittently to allow the frame capture cameras to alternate between capturing regular video frames and overlaid beams reflected from the surfaces of scanned objects. Because, in some embodiments, the positioning of the event cameras or frame cameras may be dynamically calibrated, the 3-D positions relative to the video images captured by frame cameras may be calculated as well.

In some embodiments, if a similar 3-D capture system is being used in free space, there may be a trade-off between scanning beam power and collecting enough signal compared to noisy events and other interferences. Accordingly, in some embodiments, higher beam power may give a less ambiguous signal, but if the beam power is turned too high, there may be other issues related to eye safety, tissue safety, or others. In an endoscopic application, the endoscope may be examining the inside of machinery or possibly interior tissues of a living body. In these cases, eye safety may not be an important consideration, and the laser beam power may be increased, if the beam energy does not damage any components or tissue in the scanned scene. In this case, apertures in the system may be arranged to be smaller and/or lens systems may be simpler without affecting the quality of light captured to enable 3-D measurement.

Though endoscopes may be used for biological applications, they may not be restricted to such uses. The end of an eye system similar to endoscope 300 may be placed on the end of a long probe snake for examining electrical conduits, piping, or the like. In some embodiments, the eye system as exemplified by the endoscope may be implemented in other form factors. For example, in one embodiment, a compact single-sensor eye system may be also placed near the end of a robot finger on a robot hand such as robot hand 130. The eye sensor may have a similar scale to than on endoscope 300, but instead be used for closer sensing applications. In this embodiment, the eye system may be used to detect micron-sized features of close objects as the robot hand is moved close to the surface, or may otherwise be used for close surface detection for improved gripping and positioning of objects in robotic activities. For example, in some embodiments, a 12 mm endoscope (or robot eye/finger) could with two or more apertures resolve 5 micron features over a 6.4×3.6 mm FOV with a working distance of 10 mm.

In one application according to some embodiments, an endoscope may be used to examine and cauterize tissues during an examination, such as an examination of the inside of a patient's large intestine. Similarly, other locations in a body may be amenable to examination and treatment using these techniques. Endoscopic techniques are already in use for inspection, for removal of polyps, or cauterization. In an embodiment, high resolution data may be constructed from the 3-D surfaces of the tissues being inspected. In some embodiments, optical fiber 336 may be used as a light channel for a much higher-powered beam than the scanning beam which may be used for tissue cauterization, or for some other type of treatment but referred to now as a cauterizing beam. In some embodiments, the end of fiber 336 may be directed using actuators to steer the cauterizing beam, but in some embodiments, the entire tip of the endoscope may be steered for this procedure. One example of this may be seen in view 350 of FIG. 3. A portion of tissue 351 may have an area, such as area 352 to be cauterized or otherwise treated. Accordingly, in this example, for some embodiments, cauterizing beam 354 may be scanned over the surface. At the same time, the endoscope may still be scanning beam 355 over the surface in various trajectories 356 to measure the 3-D surface. The tip could be actively moved and steered where the cauterizing beam goes to enable control of where cauterization happens, but in some variants, this may be done opportunistically. For instance, in some embodiments, the fiber or tip of the endoscope may be moved around while capturing 3-D structures of tissue in front of it. Accordingly, if a portion of the tissue has been identified and designated for cauterization, a controller of the system may be instructed which parts of the tissue structure this is based on the scanned 3-D structure information. In some embodiments, tissue identification may be implemented using shape data of features measured solely from the laser-scanning 3-D measurement system, but in other embodiments, identification may be achieved using a combination of video data from the frame capture camera with the aforementioned 3-D shape data. In some embodiments, 3-D shape data may be very specific; in some cases, certain polyps that may be likely to be removed may have certain shapes that may be correlated with tissue to be treated. In specific embodiments, artificial intelligence methods may be used to train the system to recognize tissues to be cauterized. In some embodiments, the system may work under supervision (for instance, it may flag the attention of a user to suspect tissue to be removed or cauterized), or may be trained to work automatically. In the latter case, for some embodiments, the system may be limited to only automatically remove objects less than a certain size. Since the system including cauterizing beam 354 may be well-calibrated (including knowing where the cauterizing beam is pointed), the cauterizing beam may be modulated to turn on and off quickly, and only turn on during the time periods that it may be pointed in the direction of the tissues identified for cauterization or removal. Movement of the cauterizing beam may be directed by the system or may be semi-random (possibly even as the operator of the device moves around the entire endoscope), but in either case, the 3-D measurement of the system only allows the cauterizing beam on at the right time. In some cases, the cauterizing beam may have a power profile that may be position dependent; for example, higher power could be used in one position to treat tissue in one condition, with power reduced while moving over another type of tissue. Feedback from either or both of the frame capture camera or the event sensor camera data could be used to measure the process of the treatment. The system way work well even if it is in movement with respect to the tissues being treated since it can dynamically detect and treat affected tissues as they may be measured by the system. If being used in automatic mode, the system may recognize and treat problems very quickly, which can eliminate many problems with treating the correct portion while the system is moving.

Although the invention has been discussed with respect to various embodiments, it should be recognized that the invention comprises the novel and non-obvious claims supported by this disclosure. It is to be understood that the disclosed embodiments may or may not overlap with each other. Specific different embodiments from different aspects may be combined or practiced separately.

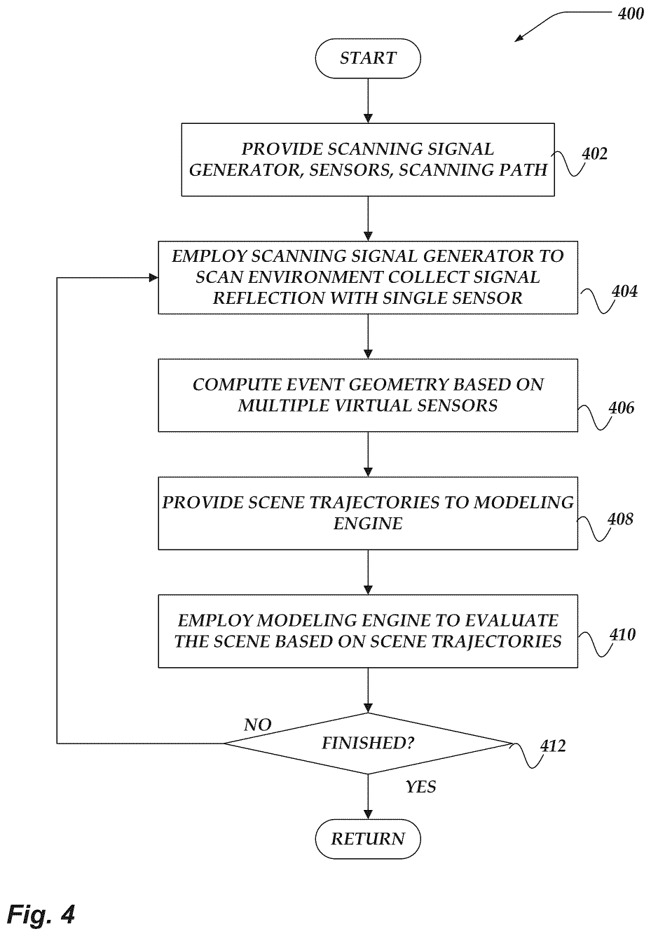

FIG. 4 illustrates an overview flowchart of process 400 for folded single sensor 3-D capture systems in accordance with one or more of the various embodiments. After a start flowchart block, at flowchart block 402, in one or more of the various embodiments, one or more scanning signal generators, one or more sensors, or the like, may be provided. Also, in some embodiments, a specific scanning path may be provided to direct the beam or signal from the scanning signal generator to traverse a specified curve or path through a scanning environment. As described above, a single event camera sensor may be provided with optical systems the enable the single event camera sensor to be employed as two or more virtual sensors. At block 404, in one or more of the various embodiments, sensing engines may be arranged to employ the scanning signal generator to scan a signal beam through the environment of interest to collect signal reflections of the signal at the single event camera sensor. At block 406, in one or more of the various embodiments, sensing engines may be arranged to provide scene trajectories based on the sensor output information. At block 408, in one or more of the various embodiments, sensing engines may be arranged to provide one or more scene trajectories to a modeling engine. At block 410, in one or more of the various embodiments, modeling engines may be arranged to evaluate the scene in the scanned environment based on the trajectories. As described herein, modeling engines may be arranged to employ various evaluation models that may be tuned or trained to identify one or more shapes, objects, object activity, or the like, based on trajectories. At decision block 412, in one or more of the various embodiments, if the scanning may be finished, control may be returned to a calling process; otherwise, control may loop back to block 404.

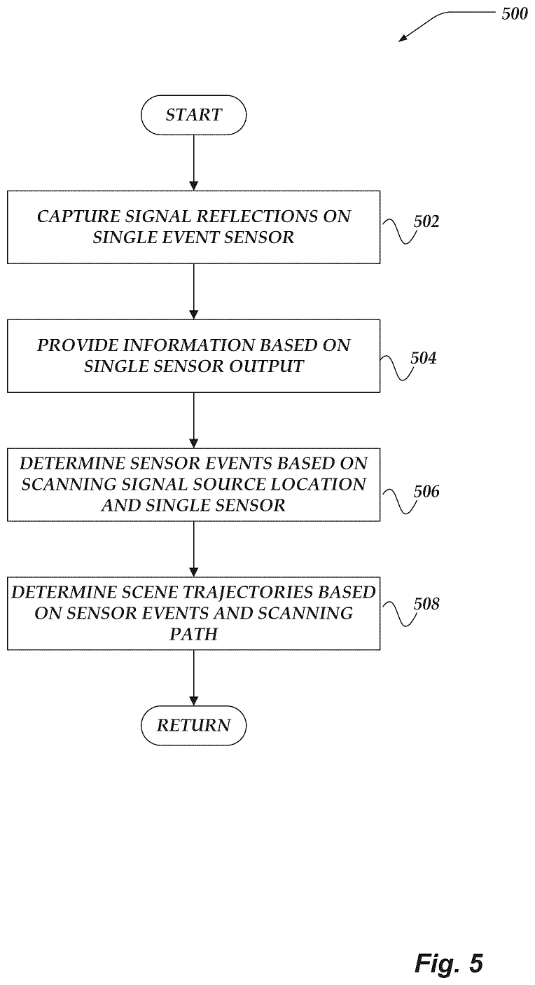

FIG. 5 illustrates a flowchart of process 500 for folded single sensor 3-D capture systems in accordance with one or more of the various embodiments. After a start block 502, in one or more of the various embodiments, a sensor may capture signal/beam reflections in the one or more sensors. At block 504, in one or more of the various embodiments, location and time information based on sensor output may be provided to sensing engine. As described above (See, at least, FIG. 2A), signal reflections may be captured through two or more different apertures and folded in toward a single event sensor by an optical focusing system included in the enclosure that includes the eye system. Accordingly, in some embodiments, separate events associated with the different apertures may occur on the same/single event camera sensor. Thus, in some embodiments, even though the same event camera is capturing more than one reflected beam, the different vantage points associated with each separate aperture may be determined based on calibration information associated with the optical focusing system that direct the captured beams into the single event camera sensor. In some embodiments, the separate events may be considered to be captured by different virtual event camera sensors that may be virtually constructed based on computations that ‘reverse’ the folding optics of optical focusing system that directed the different signals (e.g., beam reflections) to the single event camera sensor.

At block 506, in one or more of the various embodiments, sensing engines may be arranged to determine one or more sensor events based on the scanning signal source location and sensor location. At block 508, in one or more of the various embodiments, sensing engines may be arranged to determine one or more scene trajectories based on the one or more sensor events and the scanning path of the signal beam. Next, in one or more of the various embodiments, control may be returned to a calling process.

### Illustrated Operating Environment

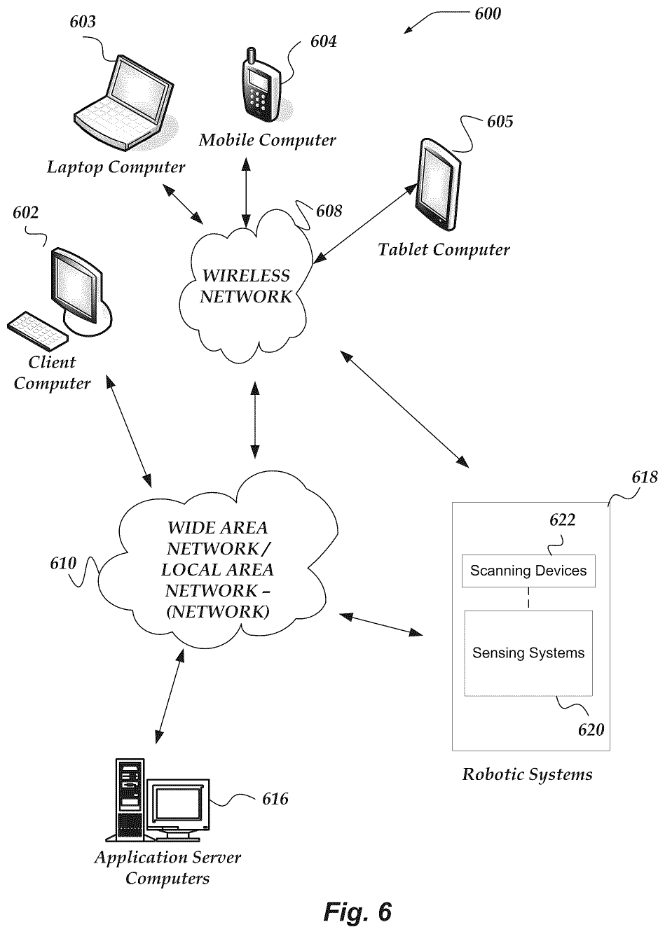

FIG. 6 shows components of one embodiment of an environment in which embodiments of the innovations may be practiced. Not all of the components may be required to practice the innovations, and variations in the arrangement and type of the components may be made without departing from the spirit or scope of the innovations. As shown, system 600 of FIG. 6 includes local area networks (LANs)/wide area networks (WANs), such as, network 610, wireless network 608, client computers 602-605, application server computer 616, robotic systems 618, or the like. In some embodiments, robotic systems 618 may include one or more of sensing systems 618, scanning devices 620, or the like.

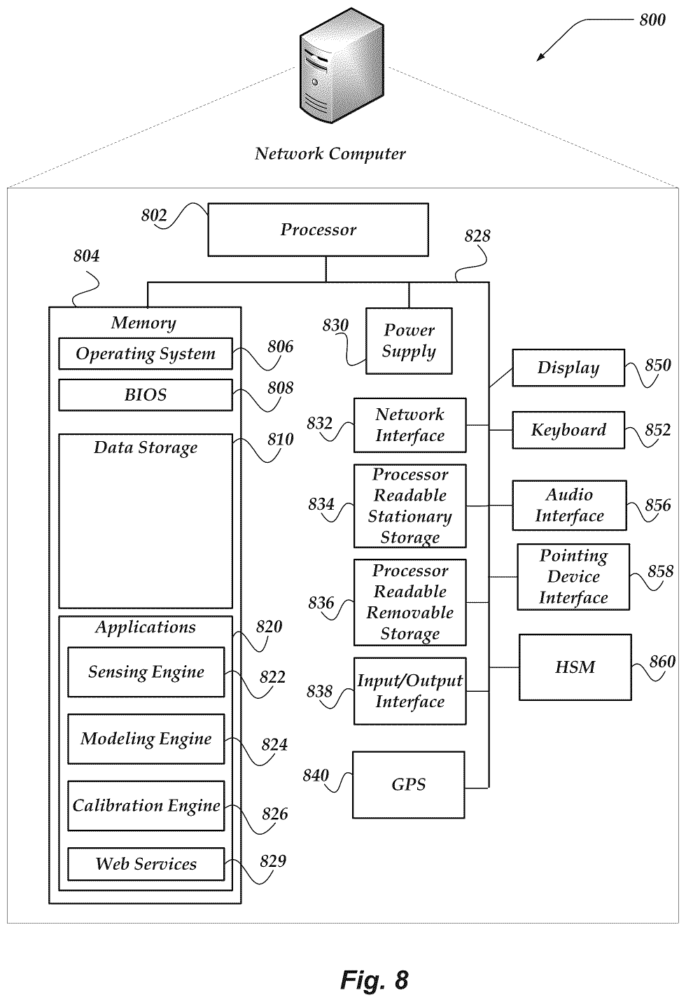

At least one embodiment of client computers 602-605 is described in more detail below in conjunction with FIG. 8. In one or more embodiments, at least some of client computers 602-605 may operate over one or more wired or wireless networks, such as networks 608, or 610. Generally, client computers 602-605 may include virtually any computer capable of communicating over a network to send and receive information, perform various online activities, offline actions, or the like. In one embodiment, one or more of client computers 602-605 may be configured to operate within a business or other entity to perform a variety of services for the business or other entity. For example, client computers 602-605 may be configured to operate as a web server, firewall, client application, media player, mobile telephone, game console, desktop computer, or the like. However, client computers 602-605 are not constrained to these services and may also be employed, for example, as for end-user computing in other embodiments. It should be recognized that more or less client computers (as shown in FIG. 6) may be included within a system such as described herein, and embodiments are therefore not constrained by the number or type of client computers employed.

Computers that may operate as client computer 602 may include computers that typically connect using a wired or wireless communications medium such as personal computers, multiprocessor systems, microprocessor-based or programmable electronic devices, network PCs, or the like. In some embodiments, client computers 602-605 may include virtually any portable computer capable of connecting to another computer and receiving information such as, laptop computer 603, mobile computer 604, tablet computers 605, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 602-605 typically range widely in terms of capabilities and features. Moreover, client computers 602-605 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one or more embodiments, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one or more embodiments, a user of the client computer may employ the browser application to perform various activities over a network (online). However, another application may also be used to perform various online activities.

Client computers 602-605 also may include at least one other client application that is configured to receive or send content between another computer. The client application may include a capability to send or receive content, or the like. The client application may further provide information that identifies itself, including a type, capability, name, and the like. In one or more embodiments, client computers 602-605 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, application server computer 616, robotic systems 618, sensing systems 620, scanning devices 622, or other computers.

Client computers 602-605 may further be configured to include a client application that enables an end-user to log into an end-user account that may be managed by another computer, such as application server computer 616, robotic systems 618, sensing systems 620, scanning devices 622, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by sensing systems 620 or scanning devices 622.

Wireless network 608 is configured to couple client computers 603-605 and its components with network 610. Wireless network 608 may include any of a variety of wireless sub-networks that may further overlay stand-alone ad-hoc networks, and the like, to provide an infrastructure-oriented connection for client computers 603-605. Such sub-networks may include mesh networks, Wireless LAN (WLAN) networks, cellular networks, and the like. In one or more embodiments, the system may include more than one wireless network.

Wireless network 608 may further include an autonomous system of terminals, gateways, routers, and the like connected by wireless radio links, and the like. These connectors may be configured to move freely and randomly and organize themselves arbitrarily, such that the topology of wireless network 608 may change rapidly.

Wireless network 608 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 603-605 with various degrees of mobility. In one non-limiting example, wireless network 608 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 608 may include virtually any wireless communication mechanism by which information may travel between client computers 603-605 and another computer, network, a cloud-based network, a cloud instance, or the like.

Network 610 is configured to couple network computers with other computers, including, application server computer 616, robotic systems 618, sensing systems 620, scanning devices 622, client computers 602, and client computers 603-605 through wireless network 608, or the like. Network 610 is enabled to employ any form of computer readable media for communicating information from one electronic device to another. Also, network 610 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices may be remotely connected to either LANs or WANs via a modem and temporary telephone link. In one or more embodiments, network 610 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

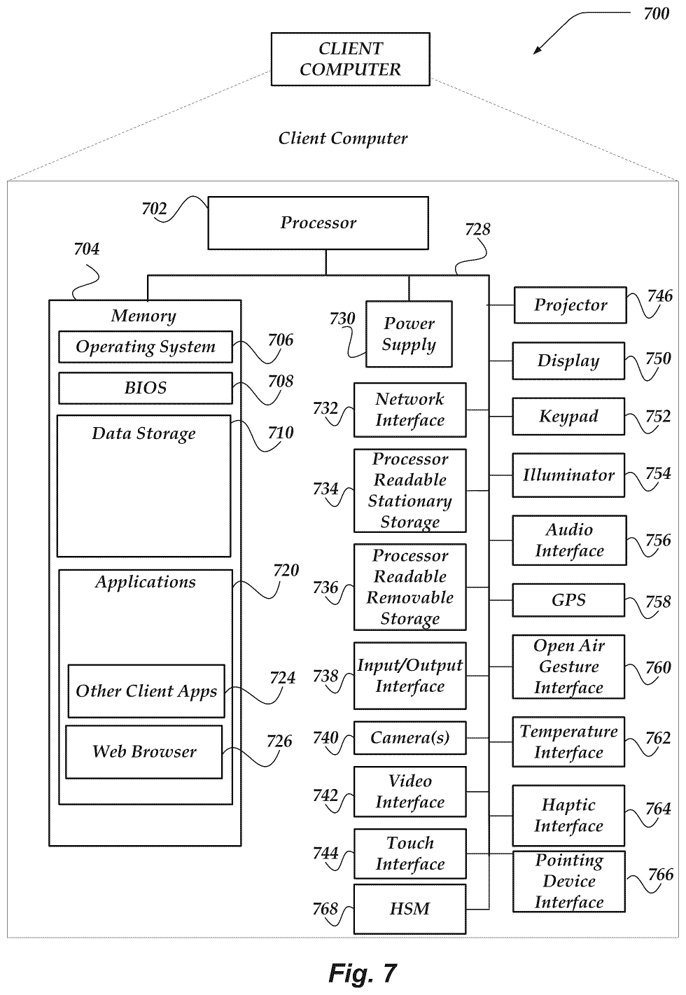

Also, one embodiment of application server computer 616, sensing systems 618 or scanning devices 620 are described in more detail below in conjunction with FIG. 7 or FIG. 8. Although FIG. 6 illustrates application server computer 616, sensing systems 620, and scanning devices 622 each as a single computer, the innovations or embodiments are not so limited. For example, one or more functions of application server computer 616, sensing systems 620, scanning devices 622, or the like, may be distributed across one or more distinct network computers, robot systems, or client computers. Moreover, in one or more embodiments, sensing systems 620 may be implemented using a plurality of network computers. Further, in one or more of the various embodiments, application server computer 616, sensing systems 620, or the like, may be implemented using one or more cloud instances in one or more cloud networks. Also, in some embodiments, application server computer 616, sensing systems 620, and scanning devices 622, or the like, may be included in robotic applications, including stationary (fixed emplacement) robots, mobile robots, or the like, as described herein. Accordingly, these innovations and embodiments are not to be construed as being limited to a single environment, and other configurations, and other architectures are also envisaged.

### Illustrative Client Computer

FIG. 7 shows one embodiment of client computer 700 that may include many more or less components than those shown. Client computer 700 may represent, for example, one or more embodiments of mobile computers or client computers shown in FIG. 6. Further, scanning devices, mobile phones, scanning devices, or the like, discussed above may be considered client computers that may be arranged in configurations or form factors as described above. In some embodiments, some or all components of client computers, such as client computer 700 may be embedded or included in a robotic system.

Client computer 700 may include processor 702 in communication with memory 704 via bus 728. Client computer 700 may also include power supply 730, network interface 732, audio interface 756, display 750, keypad 752, illuminator 754, video interface 742, input/output interface 738, haptic interface 764, global positioning systems (GPS) receiver 758, open air gesture interface 760, temperature interface 762, camera(s) 740, projector 746, pointing device interface 766, processor-readable stationary storage device 734, and processor-readable removable storage device 736. Client computer 700 may optionally communicate with a base station (not shown), or directly with another computer. And in one or more embodiments, although not shown, a gyroscope may be employed within client computer 700 to measuring or maintaining an orientation of client computer 700.

Power supply 730 may provide power to client computer 700. A rechargeable or non-rechargeable battery may be used to provide power. The power may also be provided by an external power source, such as an AC adapter or a powered docking cradle that supplements or recharges the battery.

Network interface 732 includes circuitry for coupling client computer 700 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 732 is sometimes known as a transceiver, transceiving device, or network interface card (NIC).

Audio interface 756 may be arranged to produce and receive audio signals such as the sound of a human voice. For example, audio interface 756 may be coupled to a speaker and microphone (not shown) to enable telecommunication with others or generate an audio acknowledgement for some action. A microphone in audio interface 756 can also be used for input to or control of client computer 700, e.g., using voice recognition, detecting touch based on sound, and the like.

Display 750 may be a liquid crystal display (LCD), gas plasma, electronic ink, light emitting diode (LED), Organic LED (OLED) or any other type of light reflective or light transmissive display that may be used with a computer. Display 750 may also include a touch interface 744 arranged to receive input from an object such as a stylus or a digit from a human hand, and may use resistive, capacitive, surface acoustic wave (SAW), infrared, radar, or other technologies to sense touch or gestures.

Projector 746 may be a remote handheld projector or an integrated projector that is capable of projecting an image on a remote wall or any other reflective object such as a remote screen.

Also, in some embodiments, if client computer 200 may be a scanning device, projector 746 may include one or more signal beam generators, laser scanner systems, or the like, that may be employed for scanning scene or objects as described above.

Video interface 742 may be arranged to capture video images, such as a still photo, a video segment, an infrared video, or the like. For example, video interface 742 may be coupled to a digital video camera, a web-camera, or the like. Video interface 742 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 752 may comprise any input device arranged to receive input from a user. For example, keypad 752 may include a push button numeric dial, or a keyboard. Keypad 752 may also include command buttons that are associated with selecting and sending images.

Illuminator 754 may provide a status indication or provide light. Illuminator 754 may remain active for specific periods of time or in response to event messages. For example, if illuminator 754 is active, it may backlight the buttons on keypad 752 and stay on while the client computer is powered. Also, illuminator 754 may backlight these buttons in various patterns if particular actions are performed, such as dialing another client computer. Illuminator 754 may also cause light sources positioned within a transparent or translucent case of the client computer to illuminate in response to actions.

Further, client computer 700 may also comprise hardware security module (HSM) 768 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 768 may be a stand-alone computer, in other cases, HSM 768 may be arranged as a hardware card that may be added to a client computer.

Client computer 700 may also comprise input/output interface 738 for communicating with external peripheral devices or other computers such as other client computers and network computers. The peripheral devices may include an audio headset, virtual reality headsets, display screen glasses, remote speaker system, remote speaker and microphone system, and the like. Input/output interface 738 can utilize one or more technologies, such as Universal Serial Bus (USB), Infrared, WiFi, WiMax, Bluetooth™, and the like.

Input/output interface 738 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 700.

Haptic interface 764 may be arranged to provide tactile feedback to a user of the client computer. For example, the haptic interface 764 may be employed to vibrate client computer 700 in a particular way if another user of a computer is calling. Temperature interface 762 may be used to provide a temperature measurement input or a temperature changing output to a user of client computer 700. Open air gesture interface 760 may sense physical gestures of a user of client computer 700, for example, by using single or stereo video cameras, radar, a gyroscopic sensor inside a computer held or worn by the user, or the like. Camera 740 may be used to track physical eye movements of a user of client computer 700.

Further, in some cases, if client computer 700 may be a scanning device, camera 740 may represent one or more event cameras, one or more frame cameras, or the like.

GPS transceiver 758 can determine the physical coordinates of client computer 700 on the surface of the Earth, which typically outputs a location as latitude and longitude values. GPS transceiver 758 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 700 on the surface of the Earth. It is understood that under different conditions, GPS transceiver 758 can determine a physical location for client computer 700. In one or more embodiment, however, client computer 700 may, through other components, provide other information that may be employed to determine a physical location of the client computer, including for example, a Media Access Control (MAC) address, IP address, and the like.

In at least one of the various embodiments, applications, such as, operating system 706, other client apps 724, web browser 726, or the like, may be arranged to employ geo-location information to select one or more localization features, such as, time zones, languages, currencies, calendar formatting, or the like. Localization features may be used in, file systems, user-interfaces, reports, as well as internal processes or databases. In at least one of the various embodiments, geo-location information used for selecting localization information may be provided by GPS 758. Also, in some embodiments, geolocation information may include information provided using one or more geolocation protocols over the networks, such as, wireless network 608 or network 611.

Human interface components can be peripheral devices that are physically separate from client computer 700, allowing for remote input or output to client computer 700. For example, information routed as described here through human interface components such as display 750 or keyboard 752 can instead be routed through network interface 732 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which may include a remote pico projector along with one or more cameras that remotely communicate with a separately located client computer to sense a user's gestures toward portions of an image projected by the pico projector onto a reflected surface such as a wall or the user's hand.

A client computer may include web browser application 726 that is configured to receive and to send web pages, web-based messages, graphics, text, multimedia, and the like. The client computer's browser application may employ virtually any programming language, including a wireless application protocol messages (WAP), and the like. In one or more embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 704 may include RAM, ROM, or other types of memory. Memory 704 illustrates an example of computer-readable storage media (devices) for storage of information such as computer-readable instructions, data structures, program modules or other data. Memory 704 may store BIOS 708 for controlling low-level operation of client computer 700. The memory may also store operating system 706 for controlling the operation of client computer 700. It may be appreciated that this component may include a general-purpose operating system such as a version of UNIX, or Linux®, or a specialized client computer communication operating system such as Windows Phone™, or the Symbian® operating system. The operating system may include, or interface with a Java virtual machine module that enables control of hardware components or operating system operations via Java application programs.

Memory 704 may further include one or more data storage 710, which can be utilized by client computer 700 to store, among other things, applications 720 or other data. For example, data storage 710 may also be employed to store information that describes various capabilities of client computer 700. The information may then be provided to another device or computer based on any of a variety of methods, including being sent as part of a header during a communication, sent upon request, or the like. Data storage 710 may also be employed to store social networking information including address books, buddy lists, aliases, user profile information, or the like. Data storage 710 may further include program code, data, algorithms, and the like, for use by a processor, such as processor 702 to execute and perform actions. In one embodiment, at least some of data storage 710 may also be stored on another component of client computer 700, including, but not limited to, non-transitory processor-readable removable storage device 736, processor-readable stationary storage device 734, or even external to the client computer.

Applications 720 may include computer executable instructions which, if executed by client computer 700, transmit, receive, or otherwise process instructions and data. Applications 720 may include, for example, other client applications 724, web browser 726, or the like. Client computers may be arranged to exchange communications, such as, queries, searches, messages, notification messages, event messages, sensor events, alerts, performance metrics, log data, API calls, or the like, combination thereof, with application servers or network monitoring computers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 700 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 700 may include one or more hardware microcontrollers instead of CPUs. In one or more embodiment, the one or more microcontrollers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 8 shows one embodiment of network computer 800 that may be included in a system implementing one or more of the various embodiments. Network computer 800 may include many more or less components than those shown in FIG. 8. However, the components shown are sufficient to disclose an illustrative embodiment for practicing these innovations. Network computer 800 may represent, for example, one embodiment of at least one of application server computer 616, or sensing systems 620 of FIG. 6. In some embodiments, network computers or portions thereof may be embedded or included in robotic systems.

In one or more of the various embodiments, scanning devices, sensing systems, robotic systems, mobile computers, or mobile phones may be arranged to communicate with one or more network computers, such as, network computer 800. In some embodiments, network computers may provide: software/firmware updates; backup storage; communication between or among scanning devices, robotic systems, mobile computers; or the like. In some cases, network computer 800 may be considered part of a cloud-based system that provides computational support for scanning devices, sensing systems, robotics systems, or the like.

Network computers, such as, network computer 800 may include a processor 802 that may be in communication with a memory 804 via a bus 828. In some embodiments, processor 802 may be comprised of one or more hardware processors, or one or more processor cores. In some cases, one or more of the one or more processors may be specialized processors designed to perform one or more specialized actions, such as, those described herein. Network computer 800 also includes a power supply 830, network interface 832, audio interface 856, display 850, keyboard 852, input/output interface 838, processor-readable stationary storage device 834, and processor-readable removable storage device 836. Power supply 830 provides power to network computer 800.

Network interface 832 includes circuitry for coupling network computer 800 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 832 is sometimes known as a transceiver, transceiving device, or network interface card (NIC). Network computer 800 may optionally communicate with a base station (not shown), or directly with another computer.

Audio interface 856 is arranged to produce and receive audio signals such as the sound of a human voice. For example, audio interface 856 may be coupled to a speaker and microphone (not shown) to enable telecommunication with others or generate an audio acknowledgement for some action. A microphone in audio interface 856 can also be used for input to or control of network computer 800, for example, using voice recognition.

Display 850 may be a liquid crystal display (LCD), gas plasma, electronic ink, light emitting diode (LED), Organic LED (OLED) or any other type of light reflective or light transmissive display that can be used with a computer. In some embodiments, display 850 may be a handheld projector or pico projector capable of projecting an image on a wall or other object.

Network computer 800 may also comprise input/output interface 838 for communicating with external devices or computers not shown in FIG. 8. Input/output interface 838 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 838 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 800. Human interface components may be physically separate from network computer 800, allowing for remote input or output to network computer 800. For example, information routed as described here through human interface components such as display 850 or keyboard 852 can instead be routed through the network interface 832 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 858 to receive user input.

GPS transceiver 840 can determine the physical coordinates of network computer 800 on the surface of the Earth, which typically outputs a location as latitude and longitude values. GPS transceiver 840 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 800 on the surface of the Earth. It is understood that under different conditions, GPS transceiver 840 can determine a physical location for network computer 800. In one or more embodiments, however, network computer 800 may, through other components, provide other information that may be employed to determine a physical location of the client computer, including for example, a Media Access Control (MAC) address, IP address, and the like.

In at least one of the various embodiments, applications, such as, operating system 806, sensing engine 822, modeling engine 824, calibration engine 826, web services 829, or the like, may be arranged to employ geo-location information to select one or more localization features, such as, time zones, languages, currencies, currency formatting, calendar formatting, or the like. Localization features may be used in file systems, user-interfaces, reports, as well as internal processes or databases. In at least one of the various embodiments, geo-location information used for selecting localization information may be provided by GPS 840. Also, in some embodiments, geolocation information may include information provided using one or more geolocation protocols over the networks, such as, wireless network 608 or network 610.

Memory 804 may include Random Access Memory (RAM), Read-Only Memory (ROM), or other types of memory. Memory 804 illustrates an example of computer-readable storage media (devices) for storage of information such as computer-readable instructions, data structures, program modules or other data. Memory 804 stores a basic input/output system (BIOS) 808 for controlling low-level operation of network computer 800. The memory also stores an operating system 806 for controlling the operation of network computer 800. It may be appreciated that this component may include a general-purpose operating system such as a version of UNIX®, or Linux®, or a specialized operating system such as Microsoft Corporation's Windows® operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 804 may further include one or more data storage 810, which can be utilized by network computer 800 to store, among other things, applications 820 or other data. For example, data storage 810 may also be employed to store information that describes various capabilities of network computer 800. The information may then be provided to another device or computer based on any of a variety of methods, including being sent as part of a header during a communication, sent upon request, or the like. Data storage 810 may also be employed to store social networking information including address books, buddy lists, aliases, user profile information, or the like. Data storage 810 may further include program code, data, algorithms, and the like, for use by a processor, such as processor 802 to execute and perform actions such as those actions described below. in one or more embodiments, at least some of data storage 810 may also be stored on another component of network computer 800, including, but not limited to, non-transitory media inside processor-readable removable storage device 836, processor-readable stationary storage device 834, or any other computer-readable storage device within network computer 800, or even external to network computer 800.

Applications 820 may include computer executable instructions which, if executed by network computer 800, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 820 may include sensing engine 822, modeling engine 824, calibration engine 826, web services 829, or the like, which may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, sensing engine 822, modeling engine 824, calibration engine 826, web services 829, or the like, may be operative in a cloud-based computing environment. In one or more of the various embodiments, these applications, and others, which comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to sensing engine 822, modeling engine 824, calibration engine 826, web services 829, or the like, may be provisioned and de-commissioned automatically.

Also, in one or more of the various embodiments, sensing engine 822, modeling engine 824, calibration engine 826, web services 829, or the like, may be located in virtual servers running in a cloud-based computing environment rather than being tied to one or more specific physical network computers.

Further, network computer 800 may also comprise hardware security module (HSM) 860 for providing additional tamper resistant safeguards for generating, storing or using security/cryptographic information such as, keys, digital certificates, passwords, passphrases, two-factor authentication information, or the like. In some embodiments, hardware security modules may be employed to support one or more standard public key infrastructures (PKI), and may be employed to generate, manage, or store keys pairs, or the like. In some embodiments, HSM 860 may be a stand-alone network computer, in other cases, HSM 860 may be arranged as a hardware card that may be installed in a network computer.

Additionally, in one or more embodiments (not shown in the figures), network computer 800 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiment, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

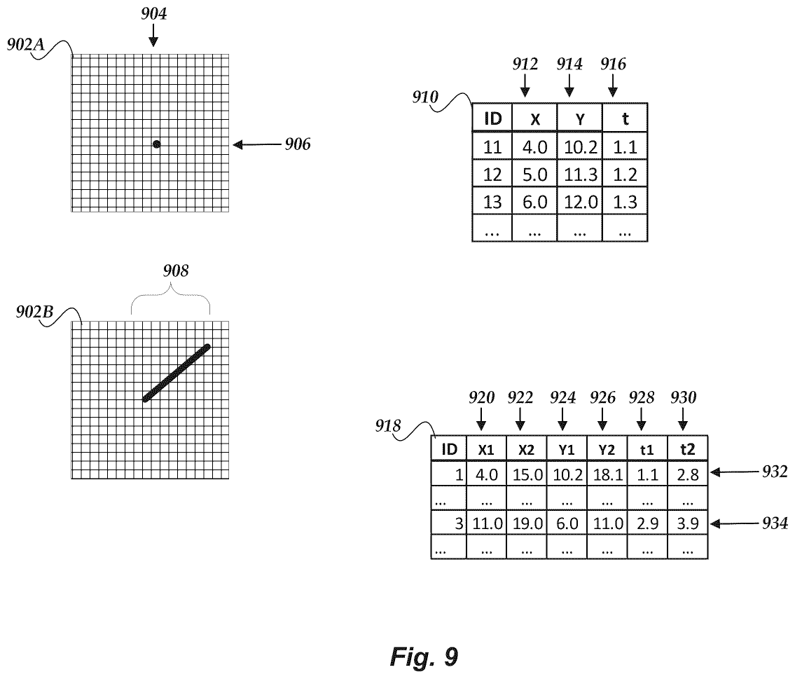

FIG. 9 illustrates a logical representation of sensors and sensor output information for folded single sensor 3-D capture systems in accordance with one or more of the various embodiments.

In one or more of the various embodiments, sensing engines running on scanning devices or in robotic systems, such as, eye 120 or eye system 140 (See, FIG. 1) may be provided sensor output from various sensors. In this example, for some embodiments, sensor 902A may be considered to represent a generic sensor that may emit signals that correspond to the precise location on the sensor where reflected energy from the scanning signal generator may be detected. For example, sensor 902A may be considered an array of detector cells that reports the cell location of the cell that has detected energy reflected from the scanning signal generator. In this example, horizontal location 904 and vertical location 906 may be considered to represent a location corresponding to the location in sensor 902 where reflected signal energy has been detected. Accordingly, sensor 902 may be considered a sensor that may be part of an event camera that may be included in a scanning device, such as, eye 120, or the like, where the signal energy may be provided scanning lasers and the reflect signal energy may be considered the laser light that may be reflected from one or more objects or surfaces in the scene.

In one or more of the various embodiments, sensing engines may be arranged to receive sensor information for one or more detection events from one or more sensors. Accordingly, in some embodiments, sensing engines may be arranged to determine additional information about the source of the reflected energy (beam location on scanned surface) based on triangulation or other methods. In some embodiments, if sensing engines employ triangulation or other methods to locate the location of the signal beam in the scanning environment, the combined sensor information may be considered a single sensor event comprising a horizontal (x) location, vertical location (y) and time component (t). Also, in some embodiments, sensor event may include other information, such as, time-of-flight information depending on the type or capability of the sensors.

Further, as described above, the scanning signal generator (e.g., scanning laser) may be configured to traverse a known precise path/curve (e.g., scanning path). Accordingly, in some embodiments, the pattern or sequence of cells in the sensors that detect reflected energy may follow a path/curve that is related to the path/curve of the scanning signal generator. Accordingly, in some embodiments, if the signal generator scans a particular path/curve a related path/curve of activated cells in the sensors may be detected. Thus, in this example, for some embodiments, path 908 may represent a sequence of cells in sensor 902B that have detected reflected energy from the scanning signal generator.

In one or more of the various embodiments, sensing engines may be arranged to fit sensor events to the scanning path curve. Accordingly, in one or more of the various embodiments, sensing engines may be arranged to predict where sensor events should occur based on the scanning path curve to determine information about the location or orientation of scanned surfaces or objects. Thus, in some embodiments, if sensing engines receive sensor events that are unassociated with the known scanning path curve, sensing engines may be arranged to perform various actions, such as, closing the current trajectory and beginning a new trajectory, discarding the sensor event as noise, or the like.

In one or more of the various embodiments, scanning path curves may be configured in advance within the limits or constraints of the scanning signal generator and the sensors. For example, a scanning signal generator may be configured or directed to scan the scanning environment using various curves including Lissajous curves, 2D lines, or the like. In some cases, scanning path curves may be considered piece-wise functions in that they may change direction or shape at different parts of the scan. For example, a 2D line scan path may be configured to change direction if the edge of the scanning environment (e.g., field-of-view) is approached.

One of ordinary skill in the art will appreciate that if an unobstructed surface is scanned, the scanning frequency, scanning path, and sensor response frequency may determine if the sensor detection path appears as a continuous path. Thus, the operational requirements of the scanning signal generator, sensor precision, sensor response frequency, or the like, may vary depending on application of the system. For example, if the scanning environment may be relatively low featured and static, the sensors may have a lower response time because the scanned environment is not changing very fast. Also, for example, if the scanning environment is dynamic or includes more features of interest, the sensors may require increased responsiveness or precision to accurately capture the paths of the reflected signal energy. Further, in some embodiments, the characteristics of the scanning signal generator may vary depending on the scanning environment. For example, if lasers are used for the scanning signal generator, the energy level, wavelength, phase, beam width, or the like, may be tuned to suit the environment.

In one or more of the various embodiments, sensing engines may be provided sensor output as a continuous stream of sensor events or sensor information that identifies the cell location in the sensor cell-array and a timestamp that corresponds to if the detection event occurred.

In this example, for some embodiments, data structure 910 may be considered a data structure for representing sensor events based on sensor output provided to a sensing engine. In this example, column 912 represents the horizontal position of the location in the scanning environment, column 914 represents a vertical position in the scanning environment, and column 916 represents the time of the event. Accordingly, in some embodiments, sensing engines may be arranged to determine which (if any) sensor events should be associated with a trajectory. In some embodiments, sensing engines may be arranged to associate sensor events with existing trajectories or create new trajectories. In some embodiments, if the sensor events fit an expected/predicted curve as determined based on the scanning path curve, sensing engines may be arranged to associate the sensor events with an existing trajectory or create a new trajectory. Also, in some cases, for some embodiments, sensing engines may be arranged to determine one or more sensor events as noise if their location deviates from a predicted path beyond a defined threshold value.

In one or more of the various embodiments, sensing engines may be arranged to determine sensor events for each individual sensor rather than being limited to provide sensor events computed based on outputs from multiple sensors. For example, in some embodiments, sensing engines may be arranged to provide a data structure similar to data structure 910 to collect sensor events for individual sensors.

In some embodiments, sensing engines may be arranged to generate a sequence of trajectories that correspond to the reflected energy/signal paths detected by the sensors. In some embodiments, sensing engines may be arranged to employ one or more data structures, such as, data structure 918 to represent a trajectory that may be determined based on the information captured by the sensors. In this example, data structure 910 may be table-like structure that includes columns, such as, column 920 for storing a first x-position, column 922 for storing a second x-position, column 924 for storing a first y-position, column 926 for storing a second y-position, column 928 for storing the beginning time of a trajectory, column 930 for storing an end time of a trajectory, of the like.

In this example, row 932 represents information for a first trajectory and row 934 represents information for another trajectory. As described herein, sensing engines may be arranged to employ one or more rules or heuristics to determine if one trajectory ends and another begins. In some embodiments, such heuristics may include observing the occurrence sensor events that are geometrically close or temporally close. Note, the particular components or elements of a trajectory may vary depending on the parametric representation of the analytical curve or the type of analytical curve associated with the scanning path and the shape or orientation of the scanned surfaces. Accordingly, one of ordinary skill in the art will appreciate that different types of analytical curves or curve representations may result in more or fewer parameters for each trajectory. Thus, in some embodiments, sensing engines may be arranged to determine the specific parameters for trajectories based on rules, templates, libraries, or the like, provided via configuration information to account for local circumstances or local requirements.

Further, one of ordinary skill in the art will appreciate that in some embodiments, trajectories may be projected/converted into 3-D scene coordinates based on calibration information, such as, the position or orientation of sensors, signal generators (e.g., scanning lasers), or the like.

In one or more of the various embodiments, trajectories may be represented using curve parameters rather than a collection of individual points or pixels. Accordingly, in some embodiments, sensing engines may be arranged to employ one or more numerical methods to continuously fit sequences of sensor events to scanning path curves.

Further, in some embodiments, sensing engines may be arranged to employ one or more smoothing methods to improve the accuracy of trajectories or trajectory fitting. For example, in some embodiments, the scanning curve may be comprised of sensor events triggered by a scanning laser that may not be one cell wide because in some cases reflected energy may splash to neighboring cells or land on the border of two or more cells. Accordingly, in some embodiments, to better estimate the real position of the reflected signal beam as it traverses the sensor plane, sensing engines may be arranged to perform an online smoothing estimate, e.g., using a Kalman filter to predict a position in a trajectory in fractional units of detector cell position and fractional units of the fundamental timestamp of the sensor. Also, in some embodiments, sensing engines may be arranged to employ a batch-based optimization routine such as weighted least squares to fit a smooth curve to continuous segments of the scanning trajectory, which may correspond to if the scanning signal generator beam was scanning over a continuous surface.

Also, in some embodiments, the scanning path may be employed to determine if trajectories begin or end. For example, if the scanning path reaches an edge of a scanning area and changes direction, in some cases, a current trajectory may be terminated while a new trajectory may be started to begin capturing information based on the new direction of the scan. Also, in some embodiments, objects or other features that occlude or obstruct scanning energy or reflected scanning energy may result in breaks in the sensor output that introduce gaps or other discontinuities that may trigger a trajectory to be closed and another trajectory to be opened subsequent to the break or gap. Further, in some embodiments, sensing engines may be configured to have a maximum length of trajectories such that a trajectory may be closed if it has collected enough sensor events or enough time has elapsed from the start of the trajectory.

Also, in some embodiments, sensing engines may be arranged to determine trajectories for individual sensor. Accordingly, in some embodiments, sensing engines may be arranged to provide data structures similar to data structure 918 for each sensor. Thus, the relative position information for different sensors or different collections of the data may be used to compute 3-D coordinates for events or trajectories.

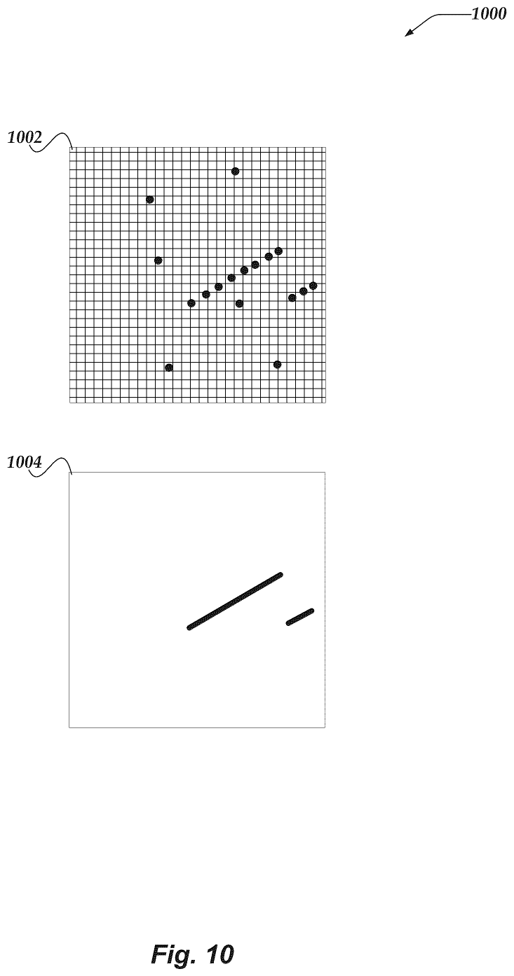

FIG. 10 illustrates a logical schematic of system 1000 for folded single sensor 3-D capture systems in accordance with one or more of the various embodiments. As described above, in some embodiments, scanning signal generators may scan for surfaces in scanning environments. In some cases, conditions of the scanning environment or characteristics of the scanned surfaces may result in one or more spurious sensor events (e.g., noise) generated by one or more sensors. For example, sensor view 1002 represents a portion of sensor events that may be generated during a scan.

In conventional machine vision applications, one or more 2D filters may be applied to a captured video image, point clusters, or the like, to attempt to separate noise events from the signals of interest. In some cases, conventional 2D image-based filters may be disadvantageous because they may employ one or more filters (e.g., weighted moving averaging, Gaussian filters, or the like) that may rely on statistical evaluation of pixel color/weight, pixel color/weight gradients, pixel distribution/clustering, or the like. Accordingly, in some cases, conventional 2D image filtering may be inherently fuzzy and highly dependent on application/environmental assumptions. Also, in some cases, conventional noise detection/noise reduction methods may erroneously miss some noise events while at the same time misclassifying one or more scene events as noise.

In contrast, in some embodiments, sensing engines may be arranged to associate sensor events into trajectories based on precise heuristics, such as, nearness in time and location that may be used to fit sensor events to analytical curves that may be predicted based on the scanning path. Because scanning paths are defined in advance, sensing engines may be arranged to predict which sensor events should be included in the same trajectory. See, trajectory view 1104.

Further, in some embodiments, if surface or object features create gaps or breaks in trajectories, sensing engines may be arranged to close the current trajectory and start a new trajectory as soon as one may be recognized.

Also, in some embodiments, sensing engines may be arranged to determine trajectories directly from sensor events having the form (x, y, t) rather than employing fuzzy pattern matching or pattern recognition methods. Thus, in some embodiments, sensing engines may be arranged to accurately compute distance, direction, or the like, rather than relying fuzzy machine vision methods to distinguish noise from sensor events that should be in the same trajectory.

In one or more of the various embodiments, calibration engines associated with sensing engines or scanning devices may be arranged to employ rules, instructions, heuristics, or the like, for classifying sensor events as noise that may be provided via configuration information to account for local requirements or local circumstances that may be associated with a sensing applications or sensors.

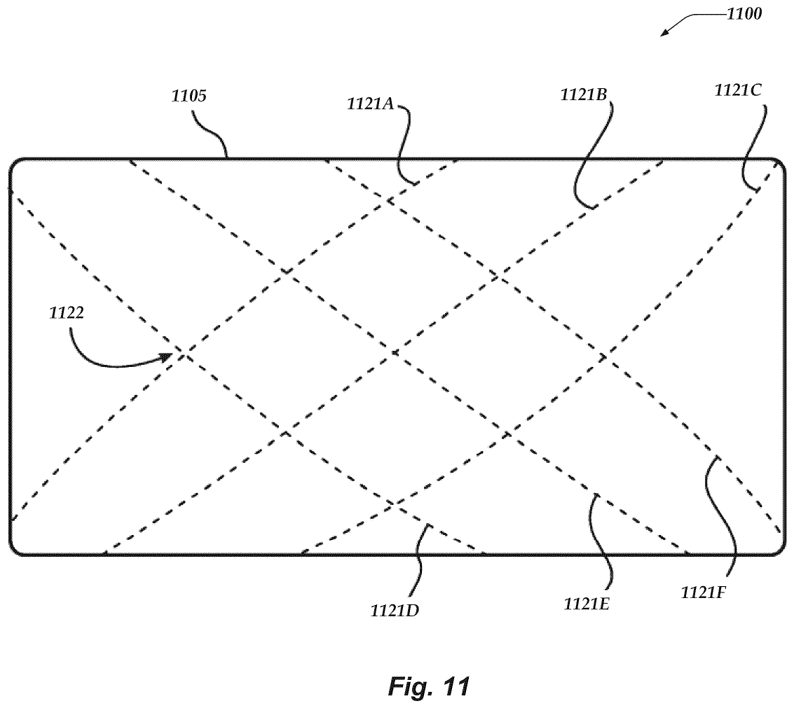

FIG. 11 illustrates how paths associated with scanned beams may traverse over or across a scene. In this example, scene 1105 represents a scanned surface or area displaying paths 1121A, 1121B, 1121C, 1121D, 1121E, and 1121F, which comprise a subset of the paths on the surface of scene 1105 in accordance with one or more of the various embodiments. A continuous portion of the path may be defined relative to parameters set on event sensors including, for example, eye 120, eye system 140, endoscope 300, or the like; although continuous paths may be defined in many ways, one way may be that neighboring or near events on a contiguous path as detected by an event sensor may be less than an arbitrary distance away from the preceding event on the path both spatially as well as in time, and generally may be produced by tracing a path on an object over a surface without significant discontinuities. In some embodiments, sensing systems may be arranged to employ rules, instructions, or the like, for determining trajectories or paths from events that may be provided via configuration information to account for local requirements or local circumstances.

In this example, crossing point 1122 may be representative of many crossing points that may occur during the scanning of an object or scene, and may be a point used as an artificial fiducial point. Though not all crossing points in FIG. 11 may be labeled as such, crossing points may be referred to by the paths which cross. For instance, point 1122 may also be named crossing point 1121AD, as this may be the crossing point of the paths 1121A and 1121D. Other crossing points may be referred to in a similar manner. For clarity, paths 1121A-F as shown may be representative of the path of a signal generator beam as it intersects the surface of an object or scene. Accordingly, events as measured on sensors included in a robot may measure these paths, but may be detected as tilted or skewed differently, since the paths as seen on each sensor may be from the perspective of the sensor in its position.

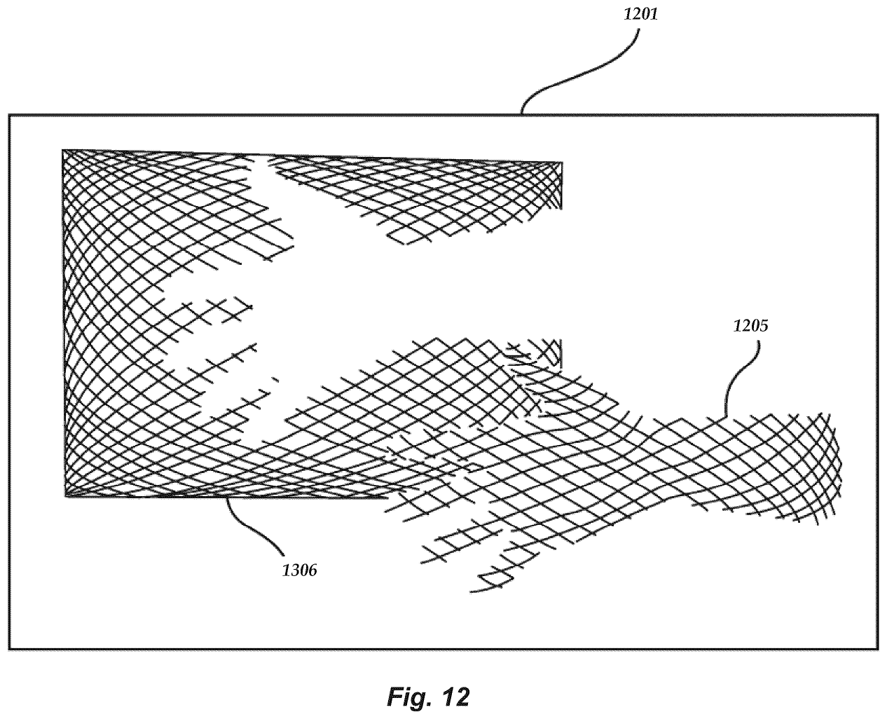

FIG. 12 illustrates a representation of how the shape or position of trajectories may correspond to the shapes or positions of subjects that may be scanned in scenes in accordance with one or more of the various embodiments. It this example, scene 1201 may be scanned by beam generators, such as, laser beams from a robot, robot eyes, robot eye systems, endoscopes, or otherwise. Accordingly, in some embodiments, a pattern of paths may be scanned across surface 1206. Also, in this example, shape 1205 may be distinguished from the background scene based on deformations or translations in the trajectories (e.g., paths) that result from the shape or position of the shape 1205 as compared to the background or other shapes that may be included in scene.

Also, it will be understood that each block (or step) in each flowchart illustration, and combinations of blocks in each flowchart illustration, may be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as may arise in a multi-processor computer system. In addition, one or more blocks or combinations of blocks in each flowchart illustration may also be performed concurrently with other blocks or combinations of blocks, or even in a different sequence than illustrated without departing from the scope or spirit of the innovations.

Accordingly, each block (or step) in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, may be implemented by special purpose hardware based systems, which perform the specified actions or steps, or combinations of special purpose hardware and computer instructions. The foregoing example should not be construed as limiting or exhaustive, but rather, an illustrative use case to show an implementation of at least one of the various embodiments of the innovations.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

Further, in some cases, for brevity or clarity, signal generators may be referred to above as lasers, scanning lasers, beams, or the like. Accordingly, one of ordinary skill in the art will appreciate that such specific references may be considered to be signal generators. Likewise, in some cases, sensors, event sensors, image sensors, or the like, may be referred to as cameras, event cameras, image cameras, frame capture cameras, or the like. Accordingly, one of ordinary skill in the art will appreciate that such specific references may be considered to be sensors, event sensors, image sensors, or the like.

What is claimed as new and desired to be protected by Letters Patent of the United States is:

1. A method for sensing objects using one or more processors to execute instructions that are configured to cause actions, comprising:
providing an enclosure that includes an event camera, one or more beam generators, and an optical focusing system, wherein the one or more beam generators scan a scene with one or more beams;
scanning a plurality of paths across one or more objects in the scene with the one or more beams;
determining a plurality of events based on detection, by the event camera, of two or more beam reflections that correspond to one or more objects in the scene, wherein each beam reflection is directed to a separate location on a sensor for the event camera by the optical focusing system;
determining a plurality of trajectories based on the plurality of paths and the plurality of events, wherein each trajectory is a parametric representation of a one-dimensional curve segment in a three-dimensional space; and
generating three-dimensional information that corresponds to the one or more objects based on the plurality of trajectories.

2. The method of claim 1, wherein determining the plurality of events, further comprises:
determining a position of each beam reflection on the sensor for the event camera based on the detection by the event camera;
determining two or more virtual event cameras based on one or more characteristics of the optical focusing system, wherein each virtual event camera includes a virtual sensor;
determining a virtual position of each event on each virtual sensor for each event camera based on the one or more characteristics of the optical focusing system; and
generating triangulation information associated with the scanned scene based on the determined virtual position of each event.

3. The method of claim 1, wherein providing the optical focusing system, further comprises:
providing two or more mirrors that direct the two or more beam reflections to the event camera, wherein each mirror is positioned to direct each beam reflection from a different aperture to a separate location on the sensor for the event camera, and wherein each mirror is one or more of a flat mirror, a spheric curved mirror, or an aspheric curved mirror.

4. The method of claim 1, wherein providing the optical focusing system, further comprises:
providing one or more filters that reduce the ambient light energy or reduce light energy from light wavelengths that are outside of a range of the one or more beams, wherein the one or more filters reduce the detection of spurious beam reflections at the sensor for the event camera.

5. The method of claim 1, wherein providing the optical focusing system, further comprises:
providing one or more wedged lenses that direct the one or more beam reflections to one or more positions on the sensor for the event camera.

6. The method of claim 1, wherein providing the optical focusing system, further comprises:
providing one or more diffractive optical elements that direct the one or more beam reflections to the sensor for the event camera.

7. The method of claim 1, wherein providing the optical focusing system, further comprises:
providing a pinhole camera to direct the one or more beam reflections to the sensor for the event camera.

8. The method of claim 1, wherein providing the enclosure, further comprises:
including the event camera, the one or more beam generators, or the optical focusing system, in an endoscope.

9. The method of claim 1, wherein providing the enclosure, further comprises:
including the event camera, the one or more beam generators, or the optical focusing system, on a robot finger.

10. The method of claim 1, wherein the enclosure further includes one or more frame cameras.

11. A scanning device for sensing objects, comprising:
a memory that stores at least instructions;
an enclosure that includes an event camera, one or more beam generators, and an optical focusing system; and
one or more processors execute instructions that are configured to cause actions, including:
scanning a scene with one or more beams from the one or more beam generators;
scanning a plurality of paths across one or more objects in the scene with the one or more beams;
determining a plurality of events based on detection, by the event camera, of two or more beam reflections that correspond to one or more objects in the scene, wherein each beam reflection is directed to a separate location on a sensor for the event camera by the optical focusing system;
determining a plurality of trajectories based on the plurality of paths and the plurality of events, wherein each trajectory is a parametric representation of a one-dimensional curve segment in a three-dimensional space; and
generating three-dimensional information that corresponds to the one or more objects based on the plurality of trajectories.

12. The scanning device of claim 11, wherein determining the plurality of events, further comprises:
determining a position of each beam reflection on the sensor for the event camera based on the detection by the event camera;
determining two or more virtual event cameras based on one or more characteristics of the optical focusing system, wherein each virtual event camera includes a virtual sensor;
determining a virtual position of each event on each virtual sensor for each event camera based on the one or more characteristics of the optical focusing system; and
generating triangulation information associated with the scanned scene based on the determined virtual position of each event.

13. The scanning device of claim 11, wherein the optical focusing system, further comprises:
two or more mirrors that direct the two or more beam reflections to the event camera, wherein each mirror is positioned to direct each beam reflection from a different aperture to a separate location on the sensor for the event camera, and wherein each mirror is one or more of a flat mirror, a spheric curved mirror, or an aspheric curved mirror.

14. The scanning device of claim 11, wherein the optical focusing system, further comprises:
one or more filters that reduce the ambient light energy or reduce light energy from light wavelengths that are outside of a range of the one or more beams, wherein the one or more filters reduce the detection of spurious beam reflections at the sensor for the event camera.

15. The scanning device of claim 11, wherein the optical focusing system, further comprises:
one or more wedged lenses that direct the one or more beam reflections to one or more positions on the sensor for the event camera.

16. The scanning device of claim 11, wherein the optical focusing system, further comprises:
one or more diffractive optical elements that direct the one or more beam reflections to the sensor for the event camera.

17. The scanning device of claim 11, wherein the optical focusing system, further comprises:
a pinhole camera to direct the one or more beam reflections to the sensor for the event camera.

18. The scanning device of claim 11, wherein the enclosure is an endoscope that includes the event camera, the one or more beam generators, or the optical focusing system.

19. The scanning device of claim 11, wherein providing the enclosure, further comprises:
including the event camera, the one or more beam generators, or the optical focusing system, on a robot finger.

20. The scanning device of claim 11, wherein the enclosure further includes one or more frame cameras.

21. A system for sensing objects:
a network computer, comprising:
a memory that stores at least instructions; and
one or more processors that execute instructions that are configured to cause actions, including:
scanning a plurality of paths across one or more objects in a scene with one or more beams;
determining a plurality of events based on detection, by an event camera, of two or more beam reflections that correspond to one or more objects in the scene, wherein each beam reflection is directed to a separate location on a sensor for an event camera by an optical focusing system;
determining a plurality of trajectories based on the plurality of paths and the plurality of events, wherein each trajectory is a parametric representation of a one-dimensional curve segment in a three-dimensional space; and
generating three-dimensional information that corresponds to the one or more objects based on the plurality of trajectories; and
an enclosure that includes:
the event camera;
the optical focusing system; and
one or more beam generators that scan the plurality of paths across the one or more objects in the scene with the one or more beams.

22. The system of claim 21, wherein determining the plurality of events, further comprises:
determining a position of each beam reflection on the sensor for the event camera based on the detection by the event camera;
determining two or more virtual event cameras based on one or more characteristics of the optical focusing system, wherein each virtual event camera includes a virtual sensor;
determining a virtual position of each event on each virtual sensor for each event camera based on the one or more characteristics of the optical focusing system; and
generating triangulation information associated with the scanned scene based on the determined virtual position of each event.

23. The system of claim 21, wherein the optical focusing system, further comprises:
two or more mirrors that direct the two or more beam reflections to the event camera, wherein each mirror is positioned to direct each beam reflection from a different aperture to a separate location on the sensor for the event camera, and wherein each mirror is one or more of a flat mirror, a spheric curved mirror, or an aspheric curved mirror.

24. The system of claim 21, wherein the optical focusing system, further comprises:
one or more filters that reduce the ambient light energy or reduce light energy from light wavelengths that are outside of a range of the one or more beams, wherein the one or more filters reduce the detection of spurious beam reflections at the sensor for the event camera.

25. The system of claim 21, wherein the optical focusing system, further comprises:
providing one or more wedged lenses that direct the one or more beam reflections to one or more positions on the sensor for the event camera.

26. The system of claim 21, wherein the optical focusing system, further comprises:
providing one or more diffractive optical elements that direct the one or more beam reflections to the sensor for the event camera.

27. The system of claim 21, wherein the optical focusing system, further comprises:
providing a pinhole camera to direct the one or more beam reflections to the sensor for the event camera.

28. The system of claim 21, wherein the enclosure is an endoscope that includes the event camera, the one or more beam generators, or the optical focusing system.

29. The system of claim 21, wherein providing the enclosure, further comprises:
including the event camera, the one or more beam generators, or the optical focusing system, on a robot finger.

30. The system of claim 21, wherein the enclosure further includes one or more frame cameras.
